(19) United States
(12) Patent Application Publication
(10) Pub. No.: US 2018/0060463 A1
(43) Pub. Date: Mar. 1, 2018

(54) Hybrid Monte Carlo and Deterministic Particle Transport Method Based on Transition Area

(71) Applicant: HEFEI INSTITUTES OF PHYSICAL SCIENCE, CAS, Hefei (CN)

(72) Inventors: Yican WU, Hefei (CN); Liqin HU, Hefei (CN); Pengcheng LONG, Hefei (CN); Lijuan HAO, Hefei (CN); Jing SONG, Hefei (CN)

(73) Assignee: HEFEI INSTITUTES OF PHYSICAL SCIENCE, CAS, Hefei (CN)

(21) Appl. No.: 15/663,164

(22) Filed: Jul. 28, 2017

(30) Foreign Application Priority Data
Aug. 30, 2016 (CN) 201610782485.3

(51) Int. Cl. G06F 17/50; G21C 17/00

(52) U.S. Cl. CPC G06F 17/5009; G21C 17/001

(57) ABSTRACT

A hybrid Mote Carlo and deterministic particle transport method based on the transition area is provided. Firstly, the geometric complexity is analyzed based on the CAD model. Based on the geometric complexity and the physical characteristics, an area having complex geometry is divided as a Monte Carlo particle transport calculation area, an area having simple geometry is divided as a deterministic particle transport calculation area, and a transition area with a determined thickness is created between the two areas. In the particle transport calculation, the Monte Carlo particle transport calculation is performed in the Monte Carlo particle transport area and the transition area, and the deterministic calculation is performed in the deterministic area and the transition area. Basically consistent results of the transition area under the two calculations can be achieved through multiple iterations, thereby realizing seamless coupling of the two calculations.

### CROSS REFERENCE TO RELATED APPLICATION

The present application claims the priority to Chinese Patent Application No. 201610782485.3, titled “HYBRID MONTE CARLO AND DETERMINISTIC PARTICLE TRANSPORT METHOD BASED ON TRANSITION AREA”, filed on Aug. 30, 2016 with the State Intellectual Property Office of the People's Republic of China, which is incorporated herein by reference in its entirety.

### TECHNICAL FIELD

The present disclosure relates to a method for calculating particle transport, a hybrid Mote Carlo and deterministic particle transport method based on a transition area, to be used in reactor shield analysis in the field of nuclear physics and nuclear technology applications.

### BACKGROUND

At present, the particle transport simulation methods usually include deterministic methods and stochastic methods (Monte Carlo (MC) method). Both methods have advantages and disadvantages. The deterministic method is to solve the transport equation by a numerical method, which has a fast calculation speed, but cannot be used to deal with complex geometry. Further, there are a variety of approximations and assumptions in the process, the calculation accuracy decreases sharply with the complexity of the problem. The MC method is to perform statistics in the area of interest by simulating real interaction between particles and the matter in the material as well as the real transport of the particles in the material, which has a high calculation precision, and can handle complex geometry. However, the MC method has the disadvantage of slow convergence, and the calculation result is not credible for an area with little statistical particles.

In the reactor shield analysis, the geometry of center area (reactor core) of the analysis model is very complex, while the geometry of peripheral area is simple. But the size of the peripheral area is very large, and there may be a thick shield layer or pores. The MC method can accurately simulate the complex geometry of the reactor core, but in the peripheral area with thick shield, since the probability of penetrating the thick shield by the particle is very low and thus the number of particles tallied after penetrating the thick shield is very small, the statistical results may be incorrect. Similarly, in the case of pores, large spaces, etc., the MC method has incorrect results due to very small statistical number. Therefore, the MC method cannot be applied to large-scale reactor shield analysis. Although the deterministic method can calculate the peripheral area of the reactor core having simple geometry in the reactor shield analysis, it cannot be used to deal with the complex geometry of the reactor core, and the calculation accuracy is poor. Therefore, for the current large-scale reactor shield analysis, there is a lack of effective and accurate particle transport simulation method.

By combining the advantages of the MC methods and deterministic methods, the hybrid Mote Carlo and deterministic transport calculation is an effective method for large-scale reactor shield calculation. At present, the hybrid Mote Carlo and deterministic transport calculation mainly has the following two problems. First, the division for MC calculation area and deterministic calculation area depends on manual analysis (such as the literature “Development of three dimensional discrete ordinates-Monte Carlo coupled system”, “A New Method for Coupling 2D and 3D Deterministic and Stochastic Radiation Transport Calculations”). The manual division requires rich user experience in calculation and analysis, easily arising mistakes. Second, the seamless coupling between the MC calculation area and the deterministic calculation areas is difficult to achieve. It is common to directly couple the two areas, with only the conversion of sources at the interface between the two areas without setting any transition areas (such as patent CN103106301B titled “Method for calculating radiation shielding based on Monte Carlo method and characteristic line method”, and literatures “Development of three dimensional discrete ordinates-Monte Carlo coupled system” and “A New Method for Coupling 2D and 3D Deterministic and Stochastic Radiation Transport Calculations”). As a result, calculation results of the two calculations for the interface are inconsistent, not achieving the seamless coupling of the two calculations and resulting in large errors in the calculation after the calculation on the interface. In some researches, a transition area is set between the MC transport calculation area and deterministic transport calculation area, but how to set the transition area, convert the sources, and achieve basically consistent results in the transition area for the two calculations to achieve seamless coupling, are still in the research stage.

### SUMMARY

The object of the present disclosure is to solve the problem that the existing manual division of Monte Carlo calculation area and deterministic calculation areas is dependent on the user experience and is error-prone, and the present disclosure is further to reduce calculation errors caused due to simple and direct coupling of two calculations. The present disclosure provides a hybrid Mote Carlo and deterministic particle transport method based on the transition area, where different calculation areas can be automatically divided, and the calculation precision can be improved through the setting of the transition layer and the iterative calculation for different areas.

The technical solution of the present disclosure is as follows. A hybrid Mote Carlo and deterministic particle transport method based on the transition area is provided. Firstly, the geometric complexity is analyzed based on the CAD model. Based on the geometric complexity and a physical characteristic, an area having complex geometry is divided as a Monte Carlo particle transport calculation area, an area having simple geometry is divided as a deterministic particle transport calculation area, and a transition area is created between the two areas. In the calculation of particle transport, the Monte Carlo particle transport calculation is performed in the Monte Carlo particle transport area and the transition area, and the deterministic calculation is performed in the deterministic area and the transition area. Basically consistent results of the transition area under the two calculations can be achieved through multiple iterations, thereby realizing seamless coupling of the two calculations.

As shown in FIG. 1, the method specifically includes the following steps.

Step (1) includes performing preliminary automatic dividing to obtain a deterministic particle transport area and a Monte Carlo particle transport area, including:

(11) generating a CAD mode based on a calculation model required for particle transport calculation; and

(12) analyzing the CAD model obtained in step (11) to obtain geometric complexity of the calculation model, analyzing a physical characteristic of the calculation model, and dividing the calculation area into the Monte Carlo particle transport area and the deterministic particle transport area, which may be implemented by steps a) to c).

a) First, a series of bounding boxes, which may be cubic, spherical or cylindrical bounding boxes, are created based on the CAD model, and complex faces in the bounding boxes are counted to obtain distribution of geometric complexity of the model.

b) A distance from a surface of the bounding box having complexity of x (the initial value is specified by the user or is set to be 0.3-0.7 times the maximum complexity of the model by a program) to the source is calculated, and a maximum attenuation coefficient w of particle transport on the surface of the bounding box is obtained based on an average free path of the particle transport in a material.

c) w is compared with the given attenuation coefficient limit w0 (which is set by the user, or is set to be 0.001-0.000001 by a program), and if w>w0, the surface of the bounding box having complexity x is selected as an interface between the Monte Carlo particle transport calculation and the deterministic particle transport calculation. The Monte Carlo particle transport calculation is performed in an area having complexity greater than x, and the deterministic particle transport calculation is performed in an area having complexity less than x. If w<w0, x is increased by y % (y is set by the user, or is set to be 0.1-0.5 by a program), and step (b) is repeated. If w<w0 after x is increased for a specified number of times (10-20), the increase is stopped, the surface of the bounding box having the complexity x is select as the interface between the Monte Carlo particle transport calculation and the deterministic particle transport calculation, the Monte Carlo particle transport calculation is performed in an area having complexity greater than x, and the deterministic particle transport calculation is performed in an area having complexity less than x.

Step (2) includes creating a transition area and determining a final deterministic transport area, including:

(21) determining the interface of the two calculation areas obtained in step (1) as one of the surfaces of the transition area in the calculation model required for particle transport calculation;

(22) automatically analyzing the physical characteristic of each cell at the surface of the transition area obtained in step (21), calculating a maximum neutron transport mean free path at the surface of the bounding box, and creating the transition area in the deterministic particle transport area obtained in step (1) using N(1 to 3) times the maximum neutron transport mean free path as the thickness of the transition area; and

(23) subtracting the transition area obtained in (22) from the deterministic particle transport area obtained in step (1), to obtain the final deterministic particle transport area.

Step (3) includes performing a seamless coupling calculation, including:

(31) simulating the Monte Carlo particle transport in the Monte Carlo particle transport area and transition area, to obtain flux of the particles in the area and surface current at the interface between the Monte Carlo particle transport area and the transition area;

(32) performing the deterministic particle transport calculation in the deterministic particle transport area and the transition area by taking the surface current at the interface between the Monte Carlo particle transport area and the transition area obtained in step (31) as a source, to obtain flux of the particles and surface current at the interface between the deterministic particle transport area and the transition area;

(33) comparing fluxes of the transition area obtained through the two calculations in steps (31) and (32); turning to step (34) if a maximum relative deviation dlt between flux calculation results of the two calculations on the transition area is smaller than a given deviation threshold dlt0 (dlt0 ranges from 0.0001 to 0.01), which indicates substantially consistent calculation results of the two calculations and seamless coupling of the two calculations; and turning step (31) by taking the surface current at the interface between the deterministic particle transport area and the transition area as a new interface reflecting source if the maximum relative deviation dlt is not less than dlt0; and

(34) combining the flux calculation results of the Monte Carlo particle transport area and the transition area obtained in (31) with the flux calculation results of the deterministic particle transport area obtained in (32), to obtain the particle flux of the whole space.

Compared with the prior art, the technical solution has the following advantages.

(1) In the hybrid Mote Carlo and deterministic particle transport method based on the transition area according to the present disclosure, the dividing for the Monte Carlo particle transport calculation area and deterministic particle transport calculation area may be automatically performed based on the geometric complexity and physical characteristic of the model. The coupling of the Monte Carlo method with the deterministic method can avoid non-effective and inaccurate calculation results obtained through the Monte Carlo method in the case of reactor shield analysis of thick shield, deep penetration and large scale.

(2) The transition layer is automatically created based on the geometric and physical characteristics, and the iterative calculation is performed, so as to achieve a continuous and smooth data field of the two calculation areas, thereby realizing the seamless coupling of the two calculations and the correctness of the final calculation results.

### BRIEF DESCRIPTION OF THE DRAWINGS

FIG. 1 is a flow chart of a method according to the present disclosure.

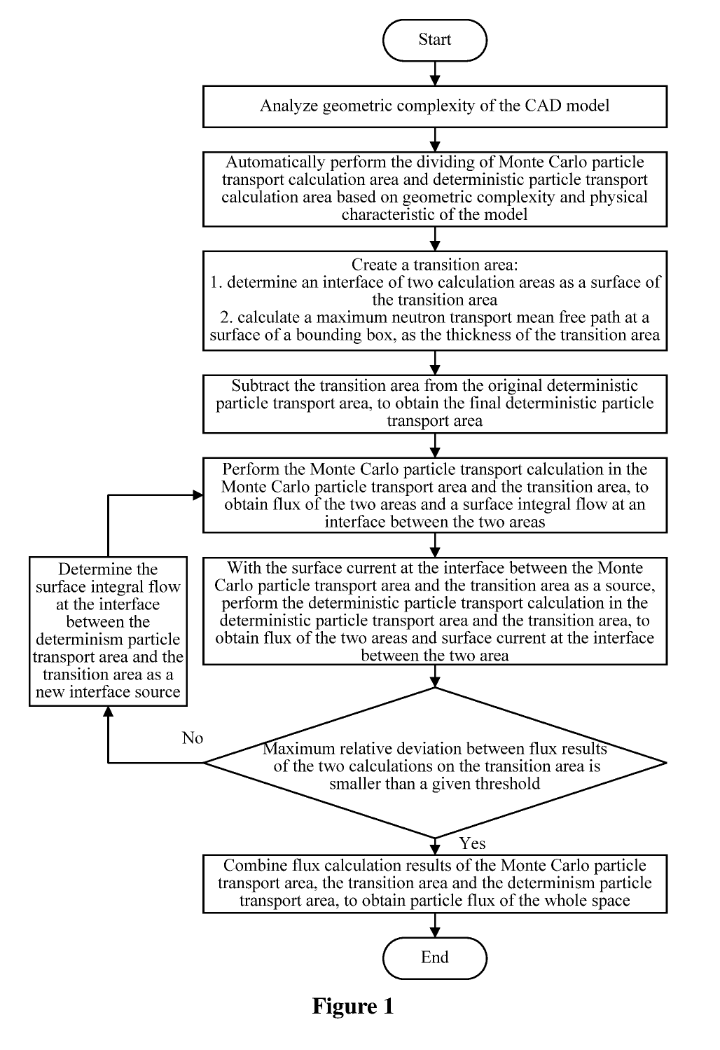

### DETAILED DESCRIPTION OF THE EMBODIMENTS

The fusion shielding benchmark are published by Alamos National Laboratory in the United States in 1991. The seventh device in that model is selected as an application example of the present disclosure. The entire model is within a rectangular box of 899.16 cm×690.85 cm×678.18 cm, includes a shield layer with a thickness of 55.88 cm, and is mainly made of iron and borated polyethylene. The cement shield structure of the model includes a deuterium tritium fusion neutron source with energy of 14 MeV and coordinates (−356.87,232.02,157.40). The volume fluxes of all the cells of the space are to be calculated.

The automatic preliminary dividing for a deterministic particle transport area and a Monte Carlo particle transport area is performed as follows.

Based on the geometrical characteristics of the fusion shielding benchmark, a cubic bounding box is selected, and the position of the neutron source is taken as the center of the bounding box. A series of nested cubic bounding boxes are set up with an initial side length of 100 cm and a side length step of 100 cm, and the geometric complexity of the bounding boxes are analyzed, to obtain a distribution map of the geometric complexity.

According to the given geometric complexity limit, a cubic bounding box with a side length of 300 cm is selected. The surface of the bounding box is made of concrete and water, and the average transport free path of the neutron with energy of 14 MeV is calculated. The maximum attenuation coefficient w of the neutron transport is calculated based on the distance from the source to the surface of the bounding box. Since the maximum attenuation coefficient w is less than a given attenuation coefficient limit w0, the surface of the bounding box with a center at the position of the neutron source and a side length of 300 cm is taken as the interface between the Monte Carlo particle transport calculation and the deterministic particle transport calculation. The inside of the bounding box is the Monte Carlo particle transport area, and the outside of the bounding box is the deterministic particle transport area.

A transition area is created as follows.

The surface of the cubic bounding box with a center at the position of the neutron source and a side length of 300 cm is taken as the surface of the transition area.

Based on the calculated maximum particle transport mean free path (about 1.5 cm in the material of water), a cubic bounding box with a side length of 301.5 cm is created, and the area between the two bounding boxes is the transition area, which has a thickness of one maximum particle transport mean free path.

The outside of the cubic bounding box with the side length of 301.5 cm is taken as the final deterministic particle transport area.

The seamless coupling calculation is performed as follows.

The Monte Carlo particle transport calculation is performed in the inside of the cubic bounding box (Monte Carlo particle transport area and transition area) with the side length of 301.5 cm, to count the volume flux of all cells in the area and the surface current at the surface of the cubic bounding box with the side length of 3500 cm.

With the surface current at the surface of the cubic bounding box with the side length of 300 cm as the source, the deterministic particle transport calculation is performed on the outside (the deterministic particle transport area and the transition area) of the cubic bounding box with the side length of 300 cm, to count the volume flux of all cells in the area and the surface current at the surface of the cubic bounding box with the side length of 301.5 cm.

The volume fluxes of the transition area obtained through the two calculations are compared. If the maximum deviation dlt of the two results is greater than a given deviation threshold dlt0, the surface current at the surface of the cubic bounding box with the side length of 301.5 cm is taken as a new reflection source for the Monte Carlo particle transport calculation, and the above-mentioned steps of the Monte Carlo and deterministic particle transport calculations are re-performed. If dlt is less than dlt0, the calculation results of the Monte Carlo particle transport area, the transition area and the deterministic particle transport area are combined, to obtain the particle flux of the whole space.

The dividing for the Monte Carlo transport calculation area and deterministic transport calculation area is automatically performed based on the geometric and physical characteristics of the model, avoiding the manual division which is dependent on the user experience and is error-prone. Further, the seamless coupling of Monte Carlo transport calculation and deterministic transport calculation is achieved through the setting of the transition layer and multiple iterations, ensuring the correctness of the final results. Therefore, an effective particle transport calculation method for large-scale reactor shield analysis is provided.

The above-mentioned embodiments are provided for the purpose of describing the present disclosure and are not intended to limit the scope of the present disclosure. The scope of the present disclosure is defined by the appended claims. Various equivalent substitutions and modifications not departing from the spirit and principles of the present disclosure fall within the scope of the present disclosure.

1. A hybrid Mote Carlo and deterministic particle transport method based on a transition area, comprising:
(1) performing preliminary automatic dividing to obtain a deterministic particle transport area and a Monte Carlo particle transport area, comprising:
(11) generating a CAD mode based on a calculation model required for particle transport calculation; and
(12) automatically analyzing the CAD model obtained in step (11) to obtain geometric complexity of the calculation model, automatically analyzing a physical characteristic of the calculation model, and dividing a calculation area into two calculation areas: the Monte Carlo particle transport area and the deterministic particle transport area, on which particle transport simulation is performed respectively with a Monte Carlo method and a deterministic method;
(2) creating a transition area and determining a final deterministic transport area, comprising:
(21) determining an interface of the two calculation areas obtained in step (1) as a surface of the transition area in the calculation model required for the particle transport calculation;
(22) automatically analyzing a physical characteristic of each cell at the surface of the transition area obtained in step (21), calculating a maximum neutron transport mean free path at a surface of a bounding box, and creating the transition area in the deterministic particle transport area obtained in step (1) using N times the maximum neutron transport mean free path as a thickness of the transition area; and
(23) subtracting the transition area obtained in (22) from the deterministic particle transport area obtained in step (1), to obtain the final deterministic particle transport area; and
(3) performing a seamless coupling calculation, comprising:
(31) simulating the Monte Carlo particle transport in the Monte Carlo particle transport area and the transition area, to obtain flux of particles and a surface current of each cell at the interface between the Monte Carlo particle transport area and the transition area;
(32) performing the deterministic particle transport calculation in the deterministic particle transport area and the transition area by taking the surface current at the interface between the Monte Carlo particle transport area and the transition area obtained in step (31) as a source, to obtain flux of the particles and surface current at the interface between the deterministic particle transport area and the transition area;
(33) comparing fluxes of the transition area obtained through the two calculations in steps (31) and (32); turning to step (34) if the maximum relative deviation between flux calculation results of the two calculations is smaller than a given deviation threshold dlt0, which indicates substantially consistent calculation results of the two calculations and seamless coupling of the two calculations; and turning to step (31) by taking the surface current at the interface between the deterministic particle transport area and the transition area as a new interface reflecting source if the maximum relative deviation is not less than dlt0; and
(34) combining flux calculation results of the Monte Carlo particle transport area and the transition area obtained in (31) with flux calculation results of the deterministic particle transport area obtained in (32), to obtain particle flux of the whole space.

2. The hybrid Mote Carlo and deterministic particle transport method based on a transition area, according to claim 1, wherein the (12) of step (1) comprising:
a) creating a series of bounding boxes based on the CAD model, and counting complex faces in the bounding boxes to obtain distribution of geometric complexity of the model;
b) calculating a distance from a surface of the bounding box having complexity of x to the source, and obtaining a maximum attenuation coefficient w of particle transport on the surface of the bounding box based on an average free path of the particle transport in a material; and
c) comparing the maximum attenuation coefficient w with a given attenuation coefficient limit w0; if w>w0, selecting the surface of the bounding box having the complexity x as an interface between the Monte Carlo particle transport calculation and the deterministic particle transport calculation, performing the Monte Carlo particle transport calculation in an area having complexity greater than x, and performing the deterministic particle transport calculation in an area having complexity less than x; if w<w0, increasing x by y % and repeating step (b), where y is set by a user or is set to be 0.1 to 0.5 by a program; if w<w0 after x is increased for a specified number of times M where M ranges from 10 to 20, stopping the increase, selecting the surface of the bounding box having the complexity x as the interface between the Monte Carlo particle transport calculation and the deterministic particle transport calculation, performing the Monte Carlo particle transport calculation in the area having the complexity greater than x, and performing the deterministic particle transport calculation in the area having the complexity less than x.

3. The hybrid Mote Carlo and deterministic particle transport method based on a transition area according to claim 1, wherein the N in step (22) ranges from 1 to 3.

4. The hybrid Mote Carlo and deterministic particle transport method based on a transition area according to claim 1, wherein the dlt0 in step (33) ranges from 0.0001 to 0.01.
